(19) United States
(12) Patent Application Publication
(10) Pub. No.: US 2011/0310053 A1
(43) Pub. Date: Dec. 22, 2011

(54) CONDUCTIVE POLYMER COMPOSITION FOR TRANSPARENT ELECTRODE AND TOUCH PANEL USING THE SAME

(75) Inventors: Sang Hwa KIM, Gyunggi-do (KR); Jong Young LEE, Gyunggi-do (KR)

(73) Assignee: SAMSUNG ELECTRO-MECHANICS CO., LTD., Gyeonggi-do (KR)

(21) Appl. No.: 12/871,767

(22) Filed: Aug. 30, 2010

(30) Foreign Application Priority Data
Jun. 17, 2010 (KR) 10-2010-0057586

(51) Int. Cl. G06F 3/041; G06F 3/045; H01B 1/12; G06F 3/044

(52) U.S. Cl. 345/174; 345/173; 252/500

(57) ABSTRACT

This invention relates to a conductive polymer composition for a transparent electrode and a touch panel using the same. The conductive polymer composition for a transparent electrode includes a polythiophene derivative, at least one dopant, at least one binder, and the remainder solvent. When the transparent electrode formed of the conductive polymer composition is used, the touch panel having high conductivity, superior transmittance, adhesion and flexibility, and a low sheet resistance of 100˜300 Ω/□ can be provided.

### CROSS REFERENCE TO RELATED APPLICATION

This application claims the benefit of Korean Patent Application No. 10-2010-0057586, filed Jun. 17, 2010, entitled “Conductive polymer composition for transparent electrode and touch panel using the same”, which is hereby incorporated by reference in its entirety into this application.

### BACKGROUND OF THE INVENTION

1. Technical Field

The present invention relates to a conductive polymer composition for a transparent electrode, and to a touch panel using the same.

2. Description of the Related Art

Alongside the rapid progression of a society based on information, computers and a variety of home appliances and communication apparatuses have become digitized and highly functionalized, and the end uses thereof have become more and more diversified. Thus, using only present input devices including keyboards, mouse elements, digitizers and so on is problematic in terms of efficiently operating the products. Accordingly, there is an increasing need for apparatuses which are simple, infrequently operate erroneously and allow anybody to easily input information.

Also, technology related to input devices exceeds the level of fulfilling general functions and thus is moving on to techniques related to reliability, durability, innovation, designing and manufacturing. For these purposes, touch panels have been developed as input devices capable of inputting information such as text and graphics.

Touch panels are mounted on the display surface of an image display device such as an electronic organizer, a flat panel display including a liquid crystal display (LCD), a plasma display panel (PDP), an electroluminescence (El) element or the like, or a cathode ray tube (CRT), so that a user selects the information desired while viewing the image display device.

Such touch panels are generally classified as being resistive, capacitive, electromagnetic, surface acoustic wave (SAW), or infrared touch panels.

The type of touch panel selected is the one that is adapted for the electronic product in terms of signal amplification problems, resolution differences, the degree of difficulty of to designing and manufacturing technology, optical properties, electrical properties, mechanical properties, resistance to the environment, input properties, durability, and economic benefits. Resistive touch panels or capacitive touch panels are particularly being prevalently used.

The resistive touch panel is configured such that upper and lower electrodes are set off from each other by spacers and come into contact with each other by pressing. Hence, when the substrate on which the upper electrode is formed is pressed by an input tool such as a user's finger or a pen, the upper and lower electrodes are electrically connected to each other, and changes in voltage depending on resistance at that position are recognized by means of a controller, thus recognizing position coordinates.

In the capacitive touch panel, when a user's finger or a conductive object disturbs a low voltage AC electrical field with the electrical field being distributed on the electrode surface, changes in current flowing from respective corners of the touch panel are measured by means of a controller so that the positions of the screen touched are determined as X and Y coordinates.

The electrode material for a display, suitable for use in such a touch panel, should be transparent and should exhibit low resistance, and also, should be highly flexible so as to be mechanically stable, and should have a coefficient of thermal expansion similar to that of the substrate such that a short circuit does not occur and changes in sheet resistance are not large even when the apparatus is overheated or is at high temperature.

However, the electrode material for a display, which is mainly used in conventional touch panels, includes a transparent conductive oxide (TCO) such as indium tin oxide (ITO) and antimony tin oxide (ATO). This is typically deposited using sputtering, and has drawbacks such as a complicated manufacturing process and high cost.

Also, the ITO electrode is disadvantageous because many cracks are generated upon formation with an organic material, and indium serving as a main ingredient is a limited mineral resource that is becoming quickly exhausted alongside expansion of the market for flat panel displays.

Furthermore, when the ITO electrode is applied to films for touch pads that have been recently receiving attention, it is difficult to manufacture such a film because of the complexity of the process and limitations of the properties of ITO.

Thorough research into replacements for ITO having the above disadvantages is being conducted. In particular, conductive polymers are receiving a lot of attention because they are flexible and inexpensive due to their simple processing.

Examples of the conductive polymer include polyaniline, polypyrrole and polythiophene. Among polythiophene derivatives, a polyethylenedioxythiophene/polystyrenesulfonate abbreviated as PEDOT/PSS was developed by Bayer (trade name: Baytron P), and has been already utilized in antistatic films.

However, the PEDOT/PSS composition has a sheet resistance on the order of 10⁵˜10⁹Ω/□, making it impossible to ensure conductive properties similar to those of ITO. The sheet resistance of the electrode for the typically displays required for touch panels which are presently commercially available is on the order of 200˜300Ω/□. Furthermore, in regard to the manufacture of touch panels including fine electrode wiring, IC enterprises and panel manufacturers require electrodes for displays to have a low sheet resistance of 200Ω/□ or less.

The conductive properties of conventional conductive polymer compositions including PEDOT/PSS may be improved on by the addition of a solvent such as dimethylsulfoxide (DMSO), ethylene glycol or sorbitol. However, conductive properties are remarkably deteriorated because of a binder or the like that is inevitably used upon actual formation of available films.

If a panel is actually manufactured without the use of the binder in order to improve conductive properties, there may occur problems, such as phase separation upon testing of reliability under conditions of high temperature and high humidity, and a drastic increase in terminal resistance attributed to a deterioration in sheet resistance.

Therefore, there is a new need for an electrode for a display which uses a conductive polymer composition having superior properties for the sake of being combined with a plastic substrate, including flexibility, film adhesion and thermal expansion, compared to those of ITO electrodes, because of the requirements of properties of the product related to the end use thereof and durability, in the field of flexible displays.

### SUMMARY OF THE INVENTION

Accordingly, the present invention has been made keeping in mind the problems encountered in the related art and the present invention is intended to provide a conductive polymer composition for a transparent electrode, which has high conductivity, superior transmittance, adhesion and flexibility, and low sheet resistance, and also to provide a touch panel using the same.

An aspect of the present invention provides a conductive polymer composition for a transparent electrode, including a polythiophene derivative represented by Formula I below; at least one dopant; at least one binder; and the remainder solvent:

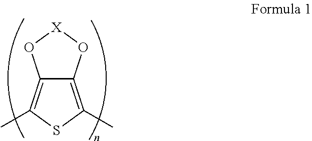

wherein x is an alkyl group having 1 or 2 carbon atoms, and n is an integer of 5 or more.

In this aspect, the polythiophene derivative may be a polyethylenedioxythiophene/polystyrenesulfonate (PEDOT/PSS).

In this aspect, the polythiophene derivative may be used in an amount of 30˜40 wt %. Also, the dopant may be an ether group-containing compound, a carbonyl group-containing compound, a polar solvent or a mixture thereof.

In this aspect, the polar solvent may be dimethylsulfoxide (DMSO), N-methylpyrrolidone (NMP), N,N-dimethylformamide (DMF), N-dimethylacetamide (DMA), or a mixture thereof, and the polar solvent may be used in an amount of 1˜10 parts by weight based on 100 parts by weight of the polythiophene derivative.

In this aspect, the binder may be an acrylic binder, an epoxy-based binder, an ester-based binder, a urethane-based binder, an ether-based binder, a carboxylic binder, an amide-based binder, or a mixture thereof. As such, the binder may be used in an amount of 1˜15 wt %.

In this aspect, the conductive polymer composition may have a sheet resistance of 100˜300 Ω/□.

Another aspect of the present invention provides a touch panel, including a first transparent substrate disposed at the upper portion of the touch panel and having one surface on which a touch is input using an input tool; a first transparent electrode formed on the other surface of the first transparent substrate and made of the conductive polymer composition as above; a second transparent substrate spaced apart from the first transparent substrate and providing a supporting force from below; a second transparent electrode formed on one surface of the second transparent substrate so as to face the first transparent electrode and made of the conductive polymer composition as above; a wiring electrode formed at an edge of the first transparent electrode and the second transparent electrode so as to receive an electrical signal from the first transparent electrode and the second transparent electrode; and an adhesive layer formed between the first transparent electrode and the second transparent electrode so that the first transparent electrode and the second transparent electrode face each other.

In this aspect, the touch panel may be a capacitive touch panel in which the adhesive layer is formed between an entire surface of the first transparent electrode and an entire surface of the second transparent electrode.

In this aspect, the touch panel may be a resistive touch panel in which the adhesive layer is formed between outside the first transparent electrode and outside the second transparent electrode and in which an insulating spacer is formed at inner region between the first transparent substrate and the second transparent substrate.

In this aspect, the adhesive layer may be either an optical clear adhesive (OCA) or double-sided adhesive tape (DAT).

In this aspect, the first transparent electrode and the second transparent electrode may have a sheet resistance of 100˜300 Ω/□.

### BRIEF DESCRIPTION OF THE DRAWINGS

The features and advantages of the present invention will be more clearly understood from the following detailed description taken in conjunction with the accompanying drawings, in which:

FIG. 1 is a cross-sectional view showing a capacitive touch panel according to an embodiment of the present invention; and

FIG. 2 is a cross-sectional view showing a resistive touch panel according to another embodiment of the present invention.

### DESCRIPTION OF SPECIFIC EMBODIMENTS

Hereinafter, embodiments of the present invention will be described in detail while referring to the accompanying drawings. Throughout the drawings, the same reference numerals are used to refer to the same or similar constituents. In the description, the terms “first”, “second” and so on are used to distinguish one constituent from another constituent, and the constituents are not defined by the above terms. Moreover, descriptions of known techniques, even if they are pertinent to the present invention, are regarded as unnecessary and may be omitted when they would make the characteristics of the invention and the description unclear.

Furthermore, the terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept implied by the term to best describe the method he or she knows for carrying out the invention.

The term “touch” used herein means not only direct touch to one surface of a transparent film but also the approach of an input tool to one surface of a transparent film with a substantial distance therebetween.

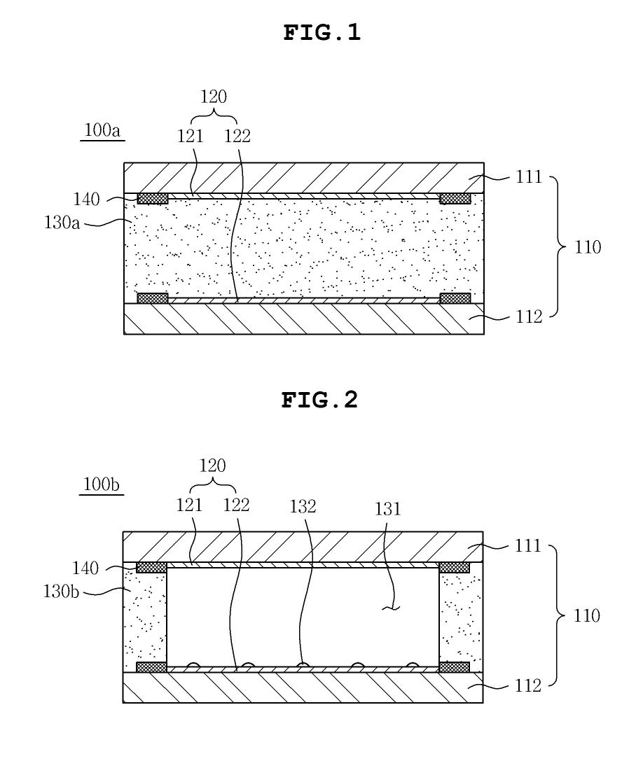

FIG. 1 is a cross-sectional view showing a capacitive touch panel according to an embodiment of the present invention.

As shown in FIG. 1, the capacitive touch panel 100a according to the embodiment of the present invention includes a first transparent substrate 111 disposed at the outermost portion of the touch panel 100a and having one surface on which a touch may be input by an input tool, a first transparent electrode 121 formed on the other surface of the first transparent substrate 111, a second transparent substrate 112, a second transparent electrode 122 formed on one surface of the second transparent substrate 112, and an adhesive layer 130a formed between the first transparent electrode 121 and the second transparent electrode 122 so that the first transparent electrode 121 and the second transparent electrode 122 face each other.

A transparent substrate 110 includes the first transparent substrate 111 and the second transparent substrate 112.

The first transparent substrate 111 is disposed at the outermost portion of the touch panel 100a, so that a touch is input to the exposed surface (one surface) thereof using an input tool including a user's body such as a finger or a stylus pen.

The material of the first transparent substrate 111 is not particularly limited as long as it is not damaged or scattered, but may include polyethyleneterephthalate (PET), polycarbonate (PC), polymethylmethacrylate (PMMA), polyethylenenaphthalate (PEN), polyethersulfone (PES), a cyclic olefin copolymer (COC), a triacetylcellulose (TAC) film, a polyvinylalcohol (PVA) film, a polyimide (PI) film, polystyrene (PS) or biaxially oriented PS (K resin containing BOPS).

Because the other surface of the first transparent substrate 111 (opposite the surface to which a touch is input by an input tool) has the first transparent electrode 121 formed thereon, it may be subjected to a pretreatment process, including the removal of impurities such as dust from the first transparent substrate 111 using an organic solvent, or modification of the surface of the first transparent substrate 111 using plasma, corona, high frequency or primer, in order to activate the surface properties of the first transparent substrate 111 (namely, in order to increase the adhesive force thereof).

The second transparent substrate 112 is disposed as a lower substrate of the capacitive touch panel 100a according to the present invention and thus plays a role in providing a supporting force from below. Because of the increased supporting force, structural stability of the touch panel may be ensured.

The second transparent substrate 112 is made of a material able to provide a supporting force greater than or equal to the predetermined durability, such as reinforced glass having superior durability, and is not particularly limited but includes for example PET, polyethylene naphthalene dicarboxylate, PC, PES, PI, COC, styrene copolymers, polyethylene, and polypropylene.

Because one surface of the second transparent substrate 112 (facing the first transparent electrode 121) has the second transparent electrode 122 formed thereon, it may be subjected to a pretreatment process as aforementioned in the first transparent substrate 111 in order to activate surface properties (namely, in order to increase adhesive force).

A transparent electrode 120 includes the first transparent electrode 121 and the second transparent electrode 122, like the transparent substrate 110 as above.

The first transparent electrode 121 functions to recognize touch coordinates in response to changes in mutual capacitance with the second transparent electrode 122 upon touch using an input tool, and is formed on the other surface of the first transparent substrate 111 so as to face the second transparent electrode 122.

The second transparent electrode 122 functions to recognize the touch coordinates together with the first transparent electrode 121, and is formed on one surface of the second transparent substrate 112 so as to face the first transparent electrode 121.

The first and second transparent electrodes 121, 122 may be formed by patterning a conductive polymer composition which is highly flexible and is readily applicable on the transparent substrate 110 using laser etching, wetting, printing, coating or deposition. The form of the pattern may assume various shapes including a diamond, a bar shape and so on, and is not limited to any one and is determined in consideration of matching properties with the ICs.

An example of the wet process may include dipping, and an example of the printing process may include gravure printing, ink-jet printing, or the like.

An example of the coating process may include spin coating, bar coating, spray coating or spreading.

In the case of laser etching or ink-jet printing, it is advantageous because a desired pattern may be easily designed and changed, and in the case of gravure printing, a roll-to-roll process is possible.

The roll-to-roll process enables very high productivity to be ensured at, low cost and has been considerably adapted for mobile and large displays, in particular, touch panel type input devices.

The conductive polymer composition for forming such first and second transparent electrodes 121, 122 includes a conductive polymer, at least one dopant, at least one binder, and the remainder solvent.

The conductive polymer is a material which has high transmittance, flexibility and uniformity, and is not particularly limited but includes polyaniline, polypyrrole or a polythiophene derivative.

In particular, the conductive polymer according to the present invention is not limited but includes for example a polythiophene derivative represented by Formula I below.

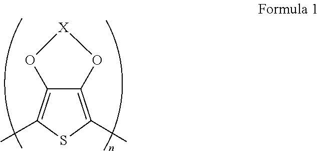

In Formula I, x is an alkyl group having 1 or 2 carbon atoms, and n is an integer of 5 or more.

As such, the polythiophene derivative includes polyethylenedioxythiophene/polystyrenesulfonate (PEDOT/PSS).

The polythiophene derivative is used in an amount of 30˜40 wt %, particularly favored being 33˜36 wt %.

If the amount of the polythiophene derivative is less than 30 wt %, upon formation of a thin film on a glass substrate, the amount of the polythiophene derivative applied on the glass substrate is small, and thus the film is formed too thin and cannot function as a transparent electrode or conductive properties may deteriorate. In contrast, if the amount of the polythiophene derivative exceeds 40 wt %, it is not easy to perform a coating process upon formation of the thin film, undesirably lowering compatibility.

Also, at least one dopant is used to improve conductive properties and may include various organic compounds.

The dopant is not particularly limited but may include an organic compound containing oxygen and nitrogen, for example, any one selected from among an ether group-containing compound, a carbonyl group-containing compound, a polar solvent, and mixtures thereof.

More specifically, the ether group-containing compound may include diethyleneglycol monoethylether. Also, the carbonyl group-containing compound may include isophorone, propylenecarbonate, cyclohexanone or butyrolactone.

In particular, the polar solvent is mainly used because its ability to improve conductive properties is superior, and is not particularly limited but includes for example any one selected from among dimethylsulfoxide (DMSO), N-methylpyrrolidone (NMP), N,N-dimethylformamide (DMF), N-dimethylacetamide (DMA), and mixtures thereof.

The dopant is used in an amount of 1˜10 parts by weight, particularly favored being 3˜8 parts by weight, based on 100 parts by weight of the polythiophene derivative.

If the amount of the dopant is less than 1 part by weight, the dopant does not have an influence on increasing conductivity. In contrast, if the amount of the dopant exceeds 10 parts by weight, there is no additional effect in terms of increasing conductivity, and thus the dopant may be wasted.

Also, the binder functions to enhance adhesion of the transparent electrode to the transparent substrate when the transparent electrode made of the conductive polymer composition according to the present invention is provided in the form of a thin film on the transparent substrate, and as well plays a role in further improving conductive properties of the conductive polymer composition and lowering sheet resistance.

The binder may be used alone or in mixtures of two or more, and is not particularly limited but includes for example any one selected from among an acrylic binder, an epoxy-based binder, an ester-based binder, a urethane-based binder, an ether-based binder, a carboxylic binder, an amide-based binder, and mixtures thereof.

Particularly useful is an acrylic binder containing alkylacrylate having an alkyl group with 3 or more carbon atoms and a monomer having a polar functional group as copolymerizable ingredients.

The binder is used in an amount of 1˜15 wt %, particularly favored being 3˜10 wt %.

If the amount of the binder is less than 1 wt %, a function of maintaining adhesion may deteriorate upon formation of a thin film and thus performance as a binder cannot be exerted. In contrast, if the amount of the binder exceeds 15 wt %, it is relatively larger than the amount of the conductive polymer, undesirably deteriorating the conductive properties.

The conductive polymer composition according to the present invention may further include a coupling agent, which aids the coupling of the transparent electrode with the transparent substrate when the transparent electrode is provided in the form of a thin film on the transparent substrate, like the binder.

The coupling agent is not particularly limited but includes for example any one selected from among γ-glycidoxypropyltrimethoxysilane, γ-glycidoxypropyltriethoxysilane, γ-glycidoxypropylethyldimethoxysilane, γ-glycidoxypropylethyldiethoxysilane, vinyltrimethoxysilane, vinyltriethoxysilane, β-glycidoxypropyltrimethoxysilane, N-β-aminoethyl-γ-aminopropyltrimethoxysilane, N-β-aminoethyl-γ-aminopropyltriethoxysilane, γ-mercaptopropyltrimethoxysilane, γ-chloropropyltrimethoxysilane, γ-acryloxypropyldimethoxysilane and mixtures thereof.

The coupling agent is used in an amount of 1˜5 wt %, particularly favored being 2˜3 wt %.

Meanwhile, in order to evaluate adhesive force of the transparent electrode and reliability of the capacitive touch panel depending on the presence or absence of the binder (and the coupling agent) in the conductive polymer composition, the following tests were performed. The results are shown in Table 1 below.

Specifically, adhesion of the transparent electrode was measured in such a manner that attachment and detachment were repeated 50 times or more using adhesive tape and a 50 mm×50 mm sized sheet of transparent electrode 100. In addition, reliability of the touch panel was measured in such a manner that changes in terminal resistance were observed under conditions of high temperature/high humidity of 80/80%.

TABLE 1

| | | | Adhesion of | |
|---|---|---|---|---|
| | | | Transparent | |
| | | | Electrode formed of | |
| | | Presence | Conductive Polymer | |
| | Presence | of | Composition | Reliability of |
| | of | Coupling | (after a certain | Capacitive Touch |
| | Binder | Agent | number of peeling) | Panel (at 80/80%) |
| Ex. 1 | Yes | Yes | 0% | Good |
| C. Ex. 1 | No | Yes | 80% Peeled | Terminal |
| | | | | Resistance |
| | | | | Increase (100% or |
| | | | | more) |
| C. Ex. 2 | No | No | 100% Peeled | Terminal |
| | | | | Resistance |
| | | | | Increase (100% or |
| | | | | more) |

As is apparent from Table 1, the conductive polymer composition of Example 1 including both the binder and the coupling agent according to the present invention can be seen to exhibit superior adhesion of the transparent electrode and good reliability of the capacitive touch panel under conditions of high temperature/high humidity.

However, in the case of the conventional conductive polymer composition of Comparative Example 1 including only the coupling agent without the binder, it can be seen that the transparent electrode is measured to be peeled off to the extent of 80%, and that a terminal resistance showing electrical properties of the touch panel is drastically increased under conditions of high temperature/high humidity.

Furthermore, in the case of the conventional conductive polymer composition of Comparative Example 2 including neither the binder nor the coupling agent, it can be seen that the transparent electrode is measured to be peeled off to the extent of 100%, and that a terminal resistance which exhibits electrical properties of the touch panel is drastically increased under conditions of high temperature/high humidity.

Specifically, it can be confirmed that both the adhesion of the transparent electrode and the reliability of the touch panel are good because of the binder that was added to the conductive polymer like in the conductive polymer composition according to the present invention.

In the case where the binder is not added like in the conventional conductive polymer compositions of Comparative Examples 1 and 2, there is a difference in the extent of being peeled off depending on whether the coupling agent is used or not. This is thought to be because the coupling agent affects the enhancement of adhesive force (adhesion) to some extent though not as much as the binder.

The conductive polymer composition according to the present invention includes the solvent, which is the remainder except for the conductive polymer, the dopant, and the binder (and the coupling agent), which are mentioned as above.

The solvent typically includes a dispersion liquid which enables solutes to be uniformly dispersed in the conductive polymer composition.

The solvent may be used alone or in mixtures of two or more, and is not particularly limited but includes for example any one selected from among an aliphatic alcohol such as methanol, ethanol, i-propanol, butanol and n-propylalcohol, an aliphatic ketone such as methyl cellosolve, propyleneglycol methylether, diacetone alcohol, ethylacetate, butylacetate, acetone and methylethylketone, an aliphatic carboxylic acid ester, an aliphatic carboxylic acid amide, an aromatic hydrocarbon, an aliphatic hydrocarbon, acetonitrile, an aliphatic sulfoxide and mixtures thereof. Alternatively, water or a blend of water and an organic solvent may be used.

The conductive polymer composition according to the present invention may further include a dispersion stabilizer, a surfactant, an antifoaming agent and a leveling agent, in addition to the conductive polymer, the dopant, the binder (and the coupling agent) and the solvent.

The dispersion stabilizer includes ethylene glycol or sorbitol which may increase conductivity.

The surfactant includes a material having a hydrophile lipophile balance (HLB) of 8˜16, particularly favored being 10˜13.

Such a surfactant is not particularly limited but includes for example Tween 20, Tween 40, Tween 60, Tween 80, Triton X-100 and so on. Furthermore, the surfactant may be mixed with a kind of material having low HLB such as span 80.

Also, the test for evaluating sheet resistance of the conductive polymer composition according to the present invention was carried out. The results are given in Table 2 below.

As such, in the conductive polymer composition according to the present invention, PEDOT/PSS was used as the polythiophene derivative, dimethylsulfoxide (DMSO) as the dopant, and i-propanol or ethanol as the solvent. Furthermore, an acrylic binder was used as the binder, and γ-glycidoxypropyltrimethoxysilane was used as the coupling agent. This test showed that the transparent electrode formed of the conductive polymer composition according to the present invention has sheet resistance lowered on the order of 100˜300Ω/□ by adjusting the ratio of the polythiophene derivative, the dopant, the solvent, the binder and the coupling agent contained in the conductive polymer composition as in Table 2 below.

TABLE 2

| | | | | | | Sheet |
|---|---|---|---|---|---|---|
| | Polythiophene | | | | Coupling | Resistance |
| | Derivative | Dopant | Solvent | Binder | Agent | (Ω/□) |
| Ex. 2 | 35 | DMSO | i- | Acryl | 1 | 300 |
| | | 1 | Propanol | 5 | | |
| | | | 58 | | | |
| Ex. 3 | 35 | DMSO | Ethanol | Acryl | 1 | 300 |
| | | 1 | 58 | 5 | | |
| Ex. 4 | 34 | DMSO | i- | Acryl | 1 | 100 |
| | | 2 | Propanol | 5 | | |
| | | | 58 | | | |
| Ex. 5 | 34 | DMSO | Ethanol | Acryl | 1 | 120 |
| | | 2 | 58 | 5 | | |
| Ex. 6 | 34 | DMSO | i- | Acryl | 1 | 230 |
| | | 3 | Propanol | 5 | | |
| | | | 57 | | | |
| Ex. 7 | 34 | DMSO | Ethanol | Acryl | 1 | 250 |
| | | 3 | 57 | 5 | | |
| C. Ex. 3 | 32 | DMSO + Ethyleneglycol | i- | — | 1 | 2500 |
| | | 14 | Propanol | | | |
| | | | 54 | | | |

As is apparent from Table 2, the conductive polymer composition according to the present invention like in Examples 2 to 7 has a smaller amount of dopant and further includes the binder, compared to the conventional conductive polymer composition of Comparative Example 3, and in particular, exhibits a sheet resistance of 100˜300Ω/□ which is much lower than the 2500Ω/□ of Comparative Example 3.

The touch panel using the transparent electrode formed of the conductive polymer composition including the conductive polymer, the dopant, the solvent and the binder (and the coupling agent) in amounts according to the present invention can possess high conductivity, superior transmittance, adhesion and flexibility, and a low sheet resistance of 100˜300 Ω/□.

With reference again to FIG. 1, a wiring electrode 140 which receives an electrical signal from each of the first transparent electrode 121 and the second transparent electrode 122 is printed on the edge of the first transparent electrode 121 and the second transparent electrode 122. As such, the wiring electrode 140 may be printed using silk screening, gravure printing or ink-jet printing. After printing of the wiring electrode 140, drying may be performed at about 150 or less, particularly favored being about 130.

The material of the wiring electrode 140 includes silver (Ag) paste or organic Ag having high electrical conductivity, but is not limited thereto, and may include a conductive polymer, carbon black (including carbon nanotubes), a metal oxide such as ITO, or low resistance metal.

The wiring electrode 140 formed of Ag paste may reduce the amount of the solvent in the paste mixture to a minimum so as to minimize the effect on the first and second transparent electrodes 121, 122 which are formed of the conductive polymer composition.

As such, the paste may have high viscosity in order to achieve a fine line width, and may contain a thixotropic agent to control printability and spreadability.

Also, in order to prevent corrosion of the paste, gold (Au) or an insulating film may be applied to a thickness of ones of urn on the wiring electrode 140.

The adhesive layer 130a is formed between the first transparent electrode 121 and the second transparent electrode 122 and plays a role in joining the faces of the first transparent electrode 121 and the second transparent electrode 122 to each other.

As such, the material of the adhesive layer 130a, which is able to mutually insulate the first transparent electrode 121 and the second transparent electrode 122 from each other, is not particularly limited but may include an optical clear adhesive (OCA) having both adhesive force and transparency.

The OCA may include an acrylic adhesive or a silicone-based adhesive. In the case of the acrylic adhesive, sheet resistance of the first and second transparent electrodes 121, 122 may be drastically increased under conditions of high temperature/high humidity. For this reason, the silicone-based adhesive may be used so as to achieve stability under conditions of high temperature/high humidity.

The OCA may be used in either its film or liquid form. After the application of the OCA, the transmittance is 99% or more. Furthermore, the thickness of the OCA is 50˜200 μm, particularly favored being 100˜175 μm.

Alternatively, the adhesive layer 130a may include double-sided adhesive tape (DAT) which is easy to rework even when defects occur in the adhesion process.

A display (not shown) may be attached to the other surface of the second transparent substrate 112 (opposite the surface on which the second transparent electrode 122 is formed) using OCA or DAT as above.

The display (not shown) may be a device for outputting an image, including a liquid crystal display device (LCD), a plasma display panel (PDP), an electroluminescence (EL) element or a cathode ray tube (CRT).

FIG. 2 is a cross-sectional view showing a resistive touch panel according to another embodiment of the present invention.

As shown in FIG. 2, the resistive touch panel 100b according to the embodiment of the present invention includes a first transparent substrate 111 disposed at the outermost portion of the touch panel 100b and having one surface on which a touch is input by an input tool, a first transparent electrode 121 formed on the other surface of the first transparent substrate 111, a second transparent substrate 112, a second transparent electrode 122 formed on one surface of the second transparent substrate 112, and an adhesive layer 130b formed between the first transparent electrode 121 and the second transparent electrode 122 so that the first transparent electrode 121 and the second transparent electrode 122 face each other.

The resistive touch panel 100b according to the present embodiment is different in terms of the configuration of the adhesive layer 130b and the presence of spacers from the capacitive touch panel 100a as mentioned above. Such a difference is mainly described below and the detailed description about the same constituents is substituted for by the above description.

The adhesive layer 130b is formed at an outer region between the first and second transparent substrates 111, 112 on which the first and second transparent electrodes 121, 122 are respectively formed. Because the adhesive layer 130b is formed at the outer region between the first and second transparent substrates 111, 112 so that the first transparent electrode 121 and the second transparent electrode 122 come into contact with each other by external pressure, a cavity 131 may be formed at an inner region therebetween.

The spacers 132 are also formed at the inner region between the first and second transparent substrates 111, 112. Such spacers 132 may be provided in the form of dot spacers, and are responsible for alleviating impact when the first transparent electrode 121 and the second transparent electrode 122 come into contact with each other and also for providing a repulsive force so that the first transparent substrate 111 returns to its original position after the pressure has been released. At normal times, the spacers function to continuously insulate the first and second transparent electrodes 121, 122 from each other so as to prevent the first transparent electrode 121 and the second transparent electrode 122 from coming into contact in the absence of external pressure.

Although the capacitive touch panel and the resistive touch panel using the transparent electrode made of the conductive polymer composition according to the present invention are described as above, the present invention is not limited thereto. Moreover, it goes without saying that the transparent electrode made of the conductive polymer composition as above may be used in various touch panels of the electromagnetic, SAW and infrared varieties.

As described hereinbefore, the present invention provides a conductive polymer composition for a transparent electrode and a touch panel using the same. According to the to present invention, as the transparent electrode made of the conductive polymer composition including a conductive polymer, a dopant, a solvent and a binder is utilized, the touch panel can exhibit high conductivity, superior transmittance, adhesion and flexibility, and a low sheet resistance of 100˜300 Ω/□.

Although the embodiments of the present invention have been disclosed for illustrative purposes, those skilled in the art will appreciate that a variety of different modifications, additions and substitutions are possible, without departing from the scope and spirit of the invention as disclosed in the accompanying claims. Accordingly, such modifications, additions and substitutions should also be understood as falling within the scope of the present invention.

1. A conductive polymer composition for a transparent electrode, comprising:
a polythiophene derivative represented by Formula I below;
at least one dopant;
at least one binder; and
a remainder solvent: 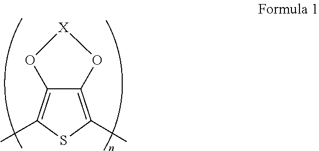
wherein x is an alkyl group having 1 or 2 carbon atoms, and n is an integer of 5 or more.

2. The conductive polymer composition as set forth in claim 1, wherein the polythiophene derivative is a polyethylenedioxythiophene/polystyrenesulfonate (PEDOT/PSS).

3. The conductive polymer composition as set forth in claim 1, wherein the polythiophene derivative is used in an amount of 30˜40 wt %.

4. The conductive polymer composition as set forth in claim 1, wherein the dopant is an ether group-containing compound, a carbonyl group-containing compound, a polar solvent or a mixture thereof.

5. The conductive polymer composition as set forth in claim 4, wherein the ether group-containing compound is diethyleneglycol monoethylether.

6. The conductive polymer composition as set forth in claim 4, wherein the carbonyl group-containing compound is isophorone, propylenecarbonate, cyclohexanone or butyrolactone.

7. The conductive polymer composition as set forth in claim 4, wherein the polar solvent is dimethylsulfoxide (DMSO), N-methylpyrrolidone (NMP), N,N-dimethylformamide (DMF), N-dimethylacetamide (DMA), or a mixture thereof.

8. The conductive polymer composition as set forth in claim 1, wherein the dopant is used in an amount of 1˜10 parts by weight based on 100 parts by weight of the polythiophene derivative.

9. The conductive polymer composition as set forth in claim 1, wherein the binder is an acrylic binder, an epoxy-based binder, an ester-based binder, a urethane-based binder, an ether-based binder, a carboxylic binder, an amide-based binder, or a mixture thereof.

10. The conductive polymer composition as set forth in claim 1, wherein the binder is used in an amount of 1˜15 wt %.

11. The conductive polymer composition as set forth in claim 1, wherein the solvent is an aliphatic alcohol, an aliphatic ketone, an aliphatic carboxylic acid ester, an aliphatic carboxylic acid amide, an aromatic hydrocarbon, an aliphatic hydrocarbon, acetonitrile, an aliphatic sulfoxide, or a mixture thereof.

12. The conductive polymer composition as set forth in claim 1, further comprising 1˜5 wt % of a coupling agent.

13. The conductive polymer composition as set forth in claim 12, wherein the coupling agent is γ-glycidoxypropyltrimethoxysilane, γ-glycidoxypropyltriethoxysilane, γ-glycidoxypropylethyldimethoxysilane, γ-glycidoxypropylethyldiethoxysilane, vinyltrimethoxysilane, vinyltriethoxysilane, β-glycidoxypropyltrimethoxysilane, N-β-aminoethyl-γ-aminopropyltrimethoxysilane, N-β-aminoethyl-γ-aminopropyltriethoxysilane, γ-mercaptopropyltrimethoxysilane, γ-chloropropyltrimethoxysilane, γ-acryloxypropyldimethoxysilane or a mixture thereof.

14. The conductive polymer composition as set forth in claim 1, further comprising a dispersion stabilizer.

15. The conductive polymer composition as set forth in claim 14, wherein the dispersion stabilizer is ethylene glycol or sorbitol.

16. The conductive polymer composition as set forth in claim 1, further comprising a surfactant.

17. The conductive polymer composition as set forth in claim 16, wherein the surfactant is a material having a hydrophile lipophile balance of 8˜16.

18. The conductive polymer composition as set forth in claim 1, which has a sheet resistance of 100˜300Ω/□.

19. A touch panel, comprising:
a first transparent substrate disposed at an upper portion of the touch panel and having one surface on which a touch is input using an input tool;
a first transparent electrode formed on the other surface of the first transparent substrate and made of the conductive polymer composition of claim 1;
a second transparent substrate spaced apart from the first transparent substrate and providing a supporting force from below;
a second transparent electrode formed on one surface of the second transparent substrate so as to face the first transparent electrode and made of the conductive polymer composition of any one of claim 1 to 18;
a wiring electrode formed at an edge of the first transparent electrode and the second transparent electrode so as to receive an electrical signal from the first transparent electrode and the second transparent electrode; and
an adhesive layer formed between the first transparent electrode and the second transparent electrode so that the first transparent electrode and the second transparent electrode face each other.

20. The touch panel as set forth in claim 19, which is a capacitive touch panel in which the adhesive layer is formed between an entire surface of the first transparent electrode and an entire surface of the second transparent electrode.

21. The touch panel as set forth in claim 19, which is a resistive touch panel in which the adhesive layer is formed between outside the first transparent electrode and outside the second transparent electrode and in which an insulating spacer is formed at inner region between the first transparent substrate and the second transparent substrate.

22. The touch panel as set forth in claim 19, wherein the adhesive layer is an optical clear adhesive (OCA) or double-sided adhesive tape (DAT).

23. The touch panel as set forth in claim 19, wherein the first transparent electrode and the second transparent electrode have a sheet resistance of 100˜300 Ω/□.
